(19) United States
(12) Patent Application Publication
(10) Pub. No.: US 2005/0215216 A1
(43) Pub. Date: Sep. 29, 2005

(54) Sigma delta modulator loop configured to compensate amplifier noise affecting signals in the AM radio frequency band

(75) Inventors: Andrew Martin Mallinson, Kelowna (CA); Simon Damphousse, Kelowna (CA)

Correspondence Address: STEVENS LAW GROUP, P.C., P.O. BOX 1667, SAN JOSE, CA, 95109, US

(73) Assignee: ESS Technology, Inc., Fremont, CA (US)

(21) Appl. No.: 10/811,480

(22) Filed: Mar. 25, 2004

(51) Int. Cl. H04B 1/00

(52) U.S. Cl. 455/222

(57) ABSTRACT

A sigma delta modulation loop circuit and related method is provided for use in a device having a radio frequency receiver. The loop is configured to compensate for noise that is generated by the sigma delta loop and that affects radio signals within the range of a radio frequency band according to the operating frequency of the radio frequency tuner.

### BACKGROUND

The invention generally relates to sigma delta modulation circuits used in conjunction with electronic amplifiers and, more particularly, to devices configured to compensate for electronic noise that affects signals that exist within radio frequency bands.

In the design of electronic devices, particularly audio devices, different and conflicting circuits must operate together. For example, in devices having radio frequency receivers, audio amplifiers are also incorporated for amplifying output signals to drive sound devices such as speakers and headphones. In practical applications, however, the incorporation of such circuits in close proximity may cause a conflict in each others operation. One conflict is with noise generated by an audio amplifier that affects signals received by a radio signal receiver, such as one that is configured with a tuner to receive radio signals in the amplitude modulation (AM) frequency band. Such noise has been found to interfere with AM signals, causing disturbances in the signals that result in poor audio output.

In conventional devices, AM signal reception, though still popular with many consumers, is often considered secondary to better quality frequency modulation (FM) signals, as well as other superior sources of audio signals, compact disc (CD) players, MP3 players, etc. Such conventional devices may include filters designed by audio device manufactures in attempts to filter out noise from the resultant AM signals. To date however, such devices continue to suffer from poor AM signal processing and reception as a result of amplifier noise.

The manufacturers who have developed products utilizing sigma-delta modulation believe it promises superior fidelity because the sigma-delta modulation processing itself enhances sound quality, and because most of it can be handled with digital signal processing circuits. Compared to PWM, which handles most processing in analog, effects that degrade fidelity, like noise and distortion, can be eliminated, making it easier to improve fidelity. Such products, however, do not address the fidelity problems associated with the AM radio frequency band.

Digital amps using sigma-delta modulation also have an advantage in that EMI counter-measures are easier to facilitate than with PWM. In PWM digital amps, the noise spectrum tends to concentrate in specific frequency components, because strong noise spectra are generated from the oscillation frequency of the PWM signal generation wave and its harmonic components. It is difficult to totally remove these components, which can, for example, affect the tuner circuits for amplitude modulation (AM) radio broadcasting. These products do not address the specific problems of AM radio broadcasting, and are directed specifically to noise distortion in the frequency modulation (FM) signal band. It is even possible that the completed products would be unable to meet EMI regulations set by the Federal Communication Commission (FCC) of the US or other national regulatory bodies. The reader is referred to “Oversampling Delta Sigma Data Converters” Theory Design and Simulation Edited by James Candy and Gabor Temes (ISBN 0-87942-285-8) as an example of conventional systems.

Therefore, there exists a need for devices that have improved performance factors and that are sensitive and responsive to signal noise that affects performance. As will be seen below, the invention accomplishes improved performance factors in an elegant manner.

### BRIEF DESCRIPTION OF DRAWINGS

FIGS. 1A and 1B are diagrammatic views of a sigma delta modulation circuit and accompanying logic according to the invention; and

FIG. 2 is a graph illustrating an output signal of a device having a radio frequency receiver and a sigma delta modulation circuit according to the invention

### DETAILED DESCRIPTION

An electronic device is provided having sigma delta modulation loop circuit for use in a device having a radio frequency receiver to compensate for noise that is generated by an electronic amplifier and that affects radio signals within the range of a radio frequency band. The sigma delta modulation loop further includes logic configured to adjust the noise transfer function of the loop in response to a change in the operating frequency of the radio receiver. In operation, the noise generated by the electronic amplifier that affects signals received by the radio receiver are compensated for by the sigma delta modulator loop. In one embodiment, a sigma delta feedback loop is configured to allow the noise transfer function of the sigma delta modulator to be modified in response to the tuning of an AM radio signal receiver, compensating for noise within a frequency range of a signal being received by the receiver.

The invention is described below in one embodiment in the context of an audio device that incorporates both audio amplifiers as well as an AM band radio receiver, where a sigma delta modulation loop circuit serves to compensate for noise generated by the audio amplifiers that may interfere with the processing of AM radio frequency signals. It will be appreciated by those skilled in the art, however, that other useful applications of the invention may be implemented without departing from the spirit and scope of the invention, where the scope is defined in the appended claims.

As discussed above, conventional audio devices often suffer from poor signal reception, particularly in the AM frequency band. Such poor reception can be caused by noise generated by audio amplifiers located in close proximity to radio signal receivers. In one embodiment, the invention is directed to a sigma delta modulation loop circuit that compensates for such noise by pinpointing a frequency range within which a radio signal receiver is tuned, and compensating for noise generated by local audio amplifiers that might interfere with such signals. This is done in one embodiment by adjusting the noise transfer function of the sigma delta modulation loop circuit to create a mathematical zero around the range within which the receiver is tuned.

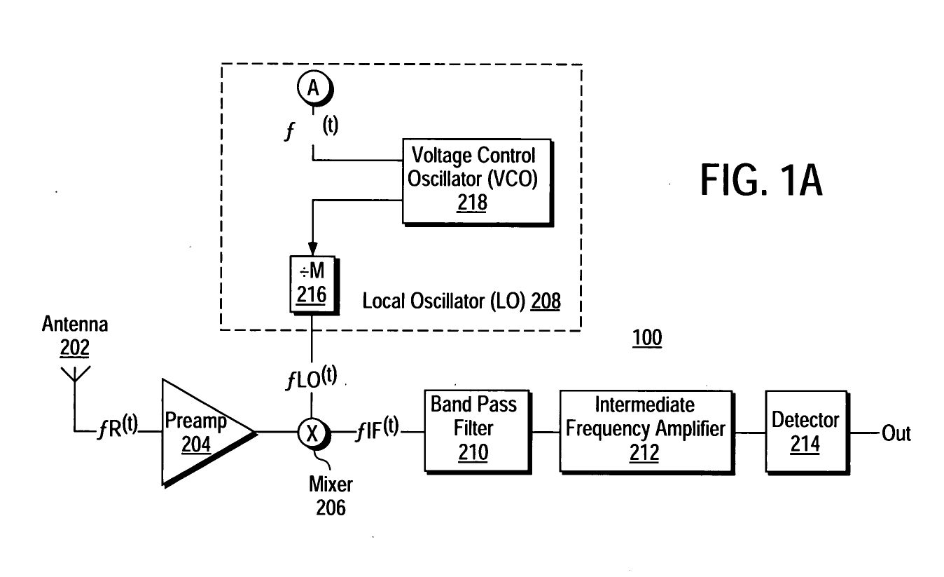

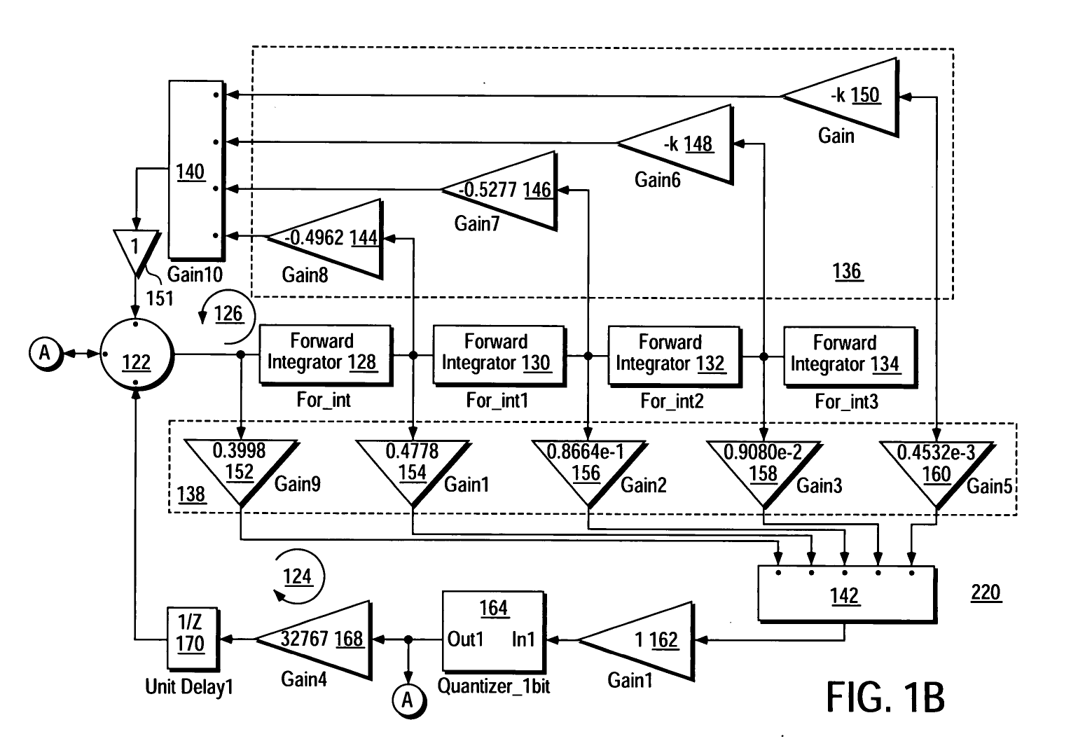

Referring to FIG. 1, a radio circuit employing one embodiment of the invention is illustrated. A radio circuit 100 is provided that is configured to shape a noise signal to reduce noise produced in the AM signal band. The circuit includes a common antenna 102 configured to receive a signal having a frequency of f_{R}(t). The signal is processed through a preamp 104, then to a mixer 106, where the incoming signal is mixed with a signal from local oscillator 108, having a frequency f_{LO}(t). The signal that is generated past the mixer has a frequency f_{IF}(t). The signal is then passed through conventional components band pass filter 110, and intermediate frequency amplifier 112 and detector 114 before it is output, where these components are those typically found in conventional superheterodyne receivers used in radios.

In a modern digitally controlled radio receiver, the local oscillator 108 includes a division block 116 that is configured to divide by a number M this is the means by which a digital control is implemented. The controlling CPU is instructed in software to set the local oscillator frequency so as to receive a certain channel. A system may therefore have the same CPU control the Sigma Delta loop of the audio output circuit. According to the invention, the noise signal control circuit 120 communicates with the VCO, and is configured to precisely place mathematic poles and zeros in the noise signal in order to reduce the noise occurring in the range of the AM signal band that the radio is set to receive. FIG. 1B illustrates a Sigma Delta converter, where the input signal representative of the audio signal to be generated is input “A” to the element 122. A sequence of pulse is generated at the output node A of FIG. 1B. This sequence has only two values and may be used to drive a Class D output stage (not shown). The Sigma Delta loop has operated to “shape the noise” caused by the quantizer element 164. The loop includes forward integrators 128, 130, 132, 134, that integrate the signal. Feedback loop 126 includes a group 136 of feedback coefficients that produce the zeros for the noise signal, which are transmitted to summer 140, then transmitted to the adder 122 through buffer 151. The purpose of each element of 136 is to introduce a zero in the noise transfer function. That is, each of the elements 144,146,148 and 150 can cause the noise present in the output signal A to have null or zero at a specific frequency. The feed-forward loop 124 includes a group 138 of coefficients, the outputs of which are transmitted to summer component 142. The feed-forward coefficients 152, 154, 156, 158 and 160 each produce a pole in the noise signal equation. The feed forward loop 124 further includes a buffer 162 followed by a single bit quantizer 164. The quantizer is followed by another buffer 168, and a unit delay 170 before the resultant feed-forward signal is transmitted to summation block 122 to be combined with the input signal and the feedback signal. The number of loop coefficients 144-160 depends on a particular application and allows a designer to optimize a given design.

This invention relates to the position of the Noise Transfer Function (NTF) zeros of such a loop. In conventional systems, the positioning of the NTF zeros has been in the band of interest in order to reduce the total in-band noise. In contrast, the invention is directed to addressing a different noise source by placing NTF zeros in a manner to minimize spurious noise generated by the loop to a position outside the band of interest for which the loop has been designed. The invention is directed to placing NTF zeros such that the loop does not generate, and hence does not radiate, spurious noise in the band to which a physically adjacent radio signal received is currently tuned. A controlling processor that sets the radio VCO frequency (and hence the radio receiver channel) also adjusts the coefficients of the Sigma Delta loop to cause at least one or more NTF zeros to be placed about the received frequency. The effect is to suppress any spurious interfering noise between the Sigma Delta loop and the radio.

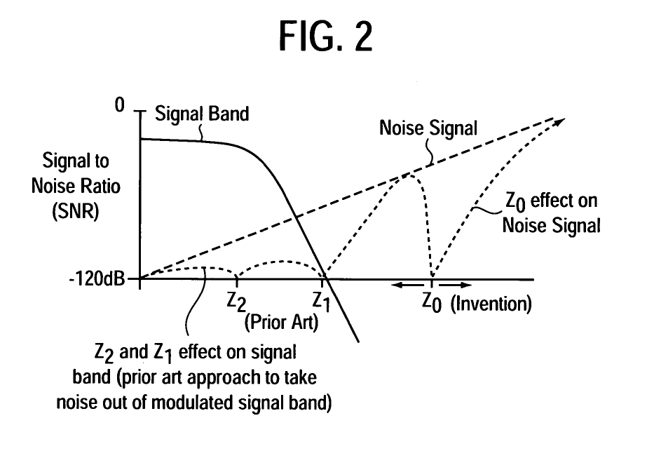

Referring to FIG. 2, a graph is shown illustrating the effect of a circuit configured according to the invention on the received radio frequency signal. The graph illustrates the signal to noise ratio (SNR) on the ordinate, and frequency on the abscissa. The signal band is shown as a decreasing slope, and the noise signal is shown as a substantially linear line increasing in slope. These signals are intended as illustrative, and may vary according to particular applications. The frequency point Z₀ is illustrated as a higher frequency that that within the frequency band of the signal band. The frequency points Z₁ and Z₂ illustrate frequency points within the signal band. Conventional circuits in the prior art have only addressed points within the signal band such as Z1 and Z2, and were directed to taking the noise out of the modulated signal band. In contrast, the invention is directed to reducing the noise signal outside the signal band. The invention is directed to points such as Z₀, which address the noise signal to improve reception of radio frequency signals. As is evident from the graphs, without the NTF zero, there would have been significant noise around the frequency Zo (the rising line notated as Noise Signal). This would have picked up as noise by a radio tuned to the frequency Zo. The beneficial effect of a circuit configured according to the invention is due to the deliberate placement of and out of signal band NTF zero at Zo is to remove this noise. Hence a radio receiving a frequency at Zo would pick up no noise from the Sigma Delta Loop. Given this description, it will be evident to those skilled in the art that a number of NTF zeros may be placed across the expected radio receive band, or one NTF zero may be moved to track the radio received frequency as it is changed by the controlling CPU.

The invention is described below in the context of embodiments of electronic devices that incorporate both audio amplifiers as well as radio frequency receivers. It will be appreciated by those skilled in the art, however, that other useful applications of the invention may be implemented for compensating for signal noise without departing from the spirit and scope of the invention, where the scope is defined in the appended claims and any equivalents.

1. An electronic device comprising:
a sigma delta modulation loop circuit for use in a device having a radio frequency receiver, wherein the loop is configured to compensate for noise that is generated by the sigma delta loop and that affects radio signals within the range of a radio frequency band according to the operating frequency of the radio frequency tuner.

2. An electronic device according to claim 1 wherein that compensation is the placement of a Noise Transfer Function zero at the operating frequency of the radio frequency tuner.

3. An electronic device according to claim 2, wherein the sigma delta modulation loop further includes logic configured to adjust its noise transfer function of the loop in response to a change in the operating frequency of the radio receiver such that the noise generated by the sigma delta loop that affects signals received by the radio receiver are compensated for by the sigma delta modulator loop.
